(19) United States
(12) Patent Application Publication
(10) Pub. No.: US 2013/0074285 A1
(43) Pub. Date: Mar. 28, 2013

(54) Hinge Assembly

(71) Applicants: Michael Hall, Provo, UT (US); Stephen Hall, Sandy, UT (US); Roberto Torres, Portland, OR (US)

(72) Inventors: Michael Hall, Provo, UT (US); Stephen Hall, Sandy, UT (US); Roberto Torres, Portland, OR (US)

(21) Appl. No.: 13/242,454

(22) Filed: Sep. 23, 2011

(51) Int. Cl. E05D 11/04; E05D 3/10

(52) U.S. Cl. 16/275; 16/367

(57) ABSTRACT

In one aspect of the present invention, a hinge joint has first and second hinge members, each with ends that have a plurality of hollow links that form a cavity configuration when the hollow links are joined. The cavity configuration has opposing openings and each opening receives a ball bearing insert. The ball bearing insert has a distal end connected to the first hinge member and a proximal end connected to the second hinge member.

### BACKGROUND OF THE INVENTION

The present invention relates generally to hinge assemblies, and especially to hinge assemblies that reduce friction as the hinge assembly translates.

U.S. Pat. No. 7,007,346 to Hoffman, which is herein incorporated by reference for all that it contains, discloses a multi-axis door mount. The multi-axis door mount provides a combination of swing-out and vertical-lift motion suitable for retrofitting a conventional swing-out automobile door for vertical-lift operation. The door is opened from a closed position in the conventional swing-out movement about a swing-out hinge. At a predetermined swing-out angle of the door to the automobile body, the door is moved in an upward vertical direction about the vertical-lift hinge. The door is closed by lowering the door to the horizontal orientation and closed in the conventional swing-in manner. A vertical-lift door system is provided to substantially incorporate the movement of a vertical-lift door with an integrated system of one or more hinges and lift assist devices. The lift assist devices provide for, singularly or in combination, among other things, controlled or deliberate movement of the door, power-assisted door operation, and/or easier integration and assembly onto the automobile.

U.S. Pat. No. 7,210,200 to Hoffman, which is herein incorporated by reference for all that it contains, discloses a multi-axis automobile door hinge, comprising a first leaf, a second leaf, and a third leaf. The first leaf and the second leaf are pivotally coupled defining a swing-out hinge adapted so as to enable rotation in a substantially horizontal plane about a substantially vertical axis of rotation. The second leaf and the third leaf are pivotally coupled about a lift bearing defining a vertical-lift hinge adapted so as to enable rotation in a substantially vertical plane about a substantially horizontal axis of rotation. The multi-axis automobile door hinge provides a combination of swing-out and vertical-lift motion suitable for retrofitting a conventional swing-out automobile door for swing-out and vertical-lift operation.

U.S. Pat. No. 5,822,832 to Maggi, which is herein incorporated by reference for all that it contains, discloses a hinge, comprising at least one first element which is fastenable to an upright member and a second element which is fastenable to a plurality of rolling bodies interposed between the first element and second element, the rolling bodies rolling along a first annular track and a second annular track respectively provided on the first element and the second element, each of said tracks having a bottom portion and two side portions, wherein the side portions are extended for retaining the rolling bodies inside the tracks during rolling of the rolling bodies along the annular tracks and form between the first element and the second element, in the region of the rolling bodies, an annular gap which is wide enough to prevent contact between the first element and the second element, said annular gap also being formed in an area located coinciding with the axes of symmetry of said first and second elements and wherein adjacent ends of the first and second elements are spaced apart by the annular gap so as to not contact one another.

### BRIEF SUMMARY OF THE INVENTION

In one aspect of the present invention, a hinge assembly has a plurality of hinge members that are moveably coupled by a plurality of hinge joints. At least two of the hinge members are object interface plates. The plates connect to first and second objects and move with respect to each other. The plurality of hinge members forms a closed configuration. Each interface plate connects to at least two hinge joints and at least two of the hinge joints comprise non-parallel axes. Additionally, each hinge joint is configured to move simultaneously.

At least one of the hinge members may have a bent geometry. The bent geometry may enable at least one of the interface plates to rotate with respect to an axis. Additionally, at least of the hinge members may translate along a trajectory that has a continuously changing direction. The continuously changing direction may enable the hinge assembly to translate through multiple directional axes.

During the translation of the hinge assembly, the assembly may collapse into a compact position. In the compact position, all of the hinge members may lie in substantially parallel planes. Additionally, a first hinge member may be adjacent to a second hinge member in the collapsed or compact position. The hinge assembly may expand such that the first and second hinge members are no longer adjacent to each other. Further, in the expanded position, each hinge member may lie in a non-parallel plane in order to support at least one of the objects. During an expansion and compression process of the hinge assembly, at least one interface plate may remain stationary. When the hinge assembly is collapsed, the assembly may form a seal with the first and second objects.

The hinge assembly may be assembled such that each end of the hinge member connects to at least one hinge joint. Additionally, each interface plate may attach to at least one hinge joint. Each interface plate may move relative to one another. A first interface plate may connect to a door and a second interface plate may connect to a door frame.

The hinge assembly may be designed such that each hinge member may translate independently from each other. Additionally, each hinge joint may have at least one ball bearing insert attached.

The closed configuration of the hinge assembly may be made up of a continuous connection of hinge members. At least two of the hinge joints in the hinge assembly may be located on non-parallel axes. The non-parallel axes may enable the hinge assembly to translate in multiple directions. Further, the hinge members may comprise different widths. The different widths may provide support to the hinge assembly and support for the objects attached to the object interface plates. An outer surface of the hinge joint may provide a seal to prevent debris from entering into the hinge joint.

In another aspect of the invention, the hinge joint has first and second hinge members, each with ends that have a plurality of hollow links that form a cavity configuration when the hollow links are joined. The cavity configuration has opposing openings and each opening receives a ball bearing insert. The ball bearing insert has a distal end connected to the first hinge member and a proximal end connected to the second hinge member.

The hinge joint may have a spring pin that is disposed along the proximal end of the ball bearing insert. The spring pin may extend inside the cavity configuration when the ball bearing insert enters into the plurality of hollow links. The spring pin may reduce friction within the hinge joint by only extending partially through the ball bearing insert. The spring may have a slot disposed within that may resiliently collapse upon insertion into the ball bearing insert. The spring pin may increase rigidity between the proximal and distal ends of the ball bearing insert because it may decrease vacancies within the insert.

The ball bearing insert may have an outside tapered surface and at least one of the hinge members may have an inside tapered surface. The outside and inside tapered surfaces may complement each other and secure the ball bearing insert within the hinge member. The proximal end of the ball bearing insert may have a peg that aids in securing the ball bearing insert into the hollow link.

An outer surface of an inside of the ball bearing insert may have threading. Preferably, the threading may be disposed along the distal end of the ball bearing insert. The threading may receive a set screw. The set screw may provide a compressive force on the ball bearing insert to aid in securing the proximal and distal ends of the ball bearing insert together.

The outer surface of the proximal end of the ball bearing insert may have an outer tapered geometry. An inner surface of the cavity configuration may have a complementary tapered geometry. The two tapered geometries may work together to secure the ball bearing insert within the cavity configuration during translation and used of the hinge assembly.

The ball bearing insert may further have a biasing mechanism disposed intermediate the proximal and distal ends of the ball bearing insert. The biasing mechanism may serve to provide a constant force to the ball bearing insert, which may increase the lifetime of the insert. The insert may further have an o-ring proximate the proximal end of the insert and the cavity configuration. The o-ring may prevent debris from entering into the insert and prevent lubricant from leaking outside of the hinge joint.

The distal and proximal ends of the ball bearing insert may be separated in part by a plurality of ball bearings. The ball bearings may be disposed within a track that is formed by the distal and proximal ends. A first end of the track may form along the distal end within a spacer. The spacer may be disposed intermediate the distal end and the ball bearings. The spacer may provide a flat, unyielding surface that the ball bearings may be loaded onto. A second end of the track may form along the proximal end within a peg or other tapered securing device. The first and second ends of the track may contact at least one ball bearing at three or more points. The track may comprise a lip that may aid in securing the ball bearings within the track. The lip may be disposed proximate the proximal and distal ends of the ball bearing insert. In some embodiments, the lip may be disposed proximate the proximal end alone and in other embodiments the lip may be disposed proximate the distal end alone.

### BRIEF DESCRIPTION OF THE DRAWINGS

FIG. 1 discloses an embodiment of a perspective view of a vehicle.

FIG. 2 discloses an embodiment of a perspective view of a vehicle.

FIG. 3 discloses an embodiment of a perspective view of a hinge assembly.

FIG. 4a discloses an embodiment of a perspective view of a hinge assembly.

FIG. 4b discloses an embodiment of a perspective view of a hinge assembly.

FIG. 4c discloses an embodiment of a perspective view of a hinge assembly.

FIG. 5 discloses an embodiment of a perspective view of a hinge assembly.

FIG. 6a discloses an embodiment of a perspective view of a hinge assembly.

FIG. 6b discloses an embodiment of a cross-sectional view of a hinge assembly.

FIG. 7 discloses an embodiment of a cross-sectional view of a ball bearing insert.

FIG. 8 discloses an embodiment of a cross-sectional view of a ball bearing insert.

FIG. 9 discloses an embodiment of a cross-sectional view of a ball bearing insert.

FIG. 10 discloses an embodiment of a cross-sectional view of a ball bearing insert.

### DETAILED DESCRIPTION OF THE INVENTION AND THE PREFERRED EMBODIMENTS

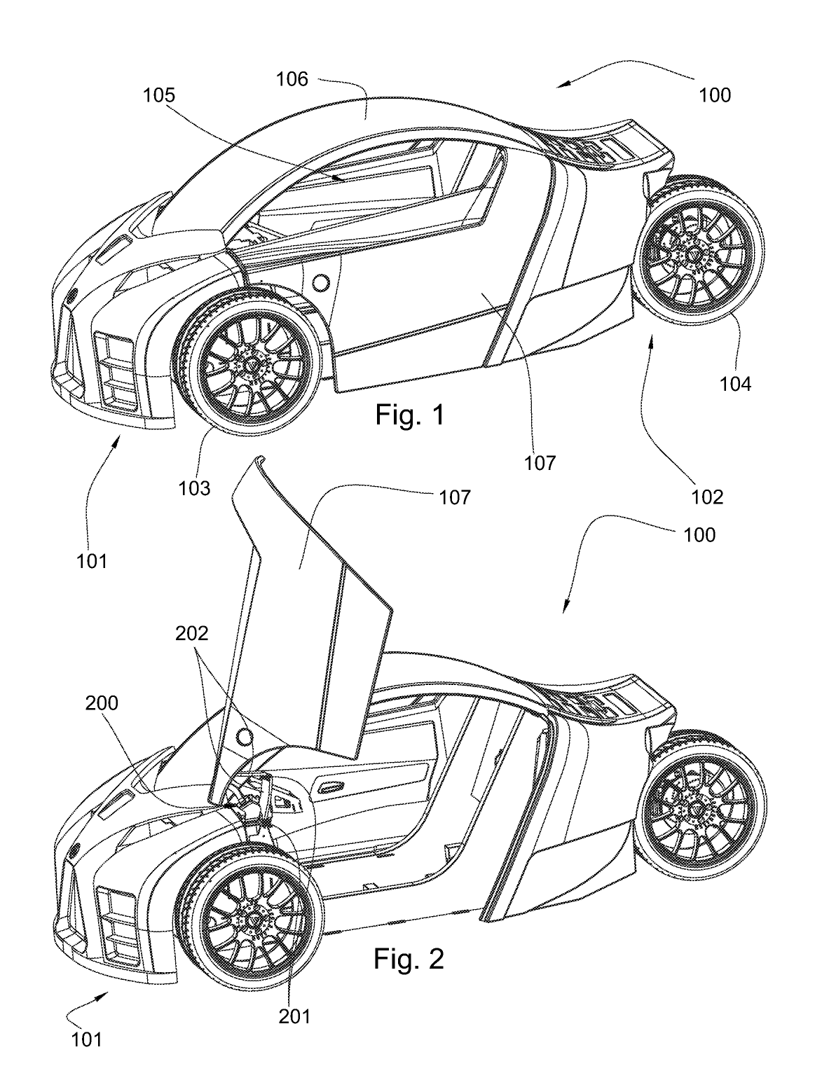

Referring now to the figures, FIG. 1 discloses an embodiment of a perspective view of a vehicle 100. The vehicle 100 may comprise a vehicle frame with a front portion 101 and a rear portion 102. Two steerable front wheels 103 may connect to the front portion 101 and a single rear wheel 104 may connect to the rear portion 102. The vehicle 100 may comprise an enclosed passenger compartment 105, surrounded by a deformation resistant roll cage 106. A door 107 may be disposed intermediate the front and rear portions 101, 102 enabling entrance into the vehicle 100.

FIG. 2 discloses an embodiment of another perspective view of the vehicle 100. The front portion 101 of the vehicle 1100 may comprise a hinge assembly 200. The hinge assembly 200 may be configured to provide a force that is necessary to propel the vehicle door 107 open. The force exerted along the hinge assembly 200 may force the door 107 to simultaneously swing outwards and upwards providing entrance into the vehicle 100. A plurality of hinge members 202 that are moveably coupled by a plurality of hinge joints 201 may be disposed on the hinge assembly 200. This may enable the assembly 200 to perform a door opening action.

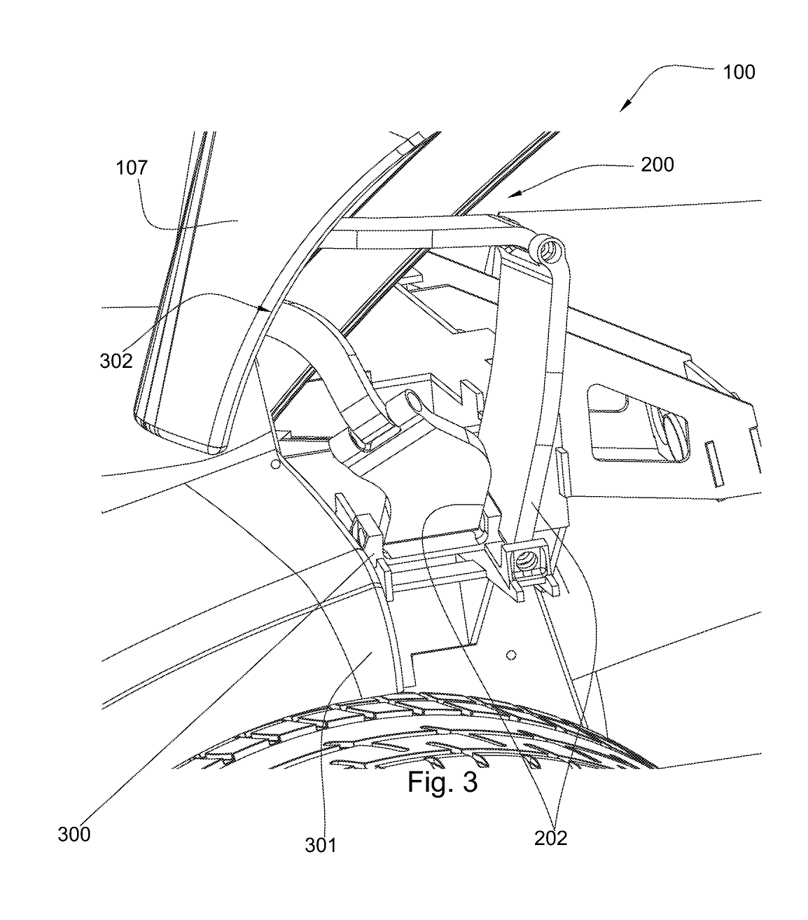

FIG. 3 discloses an embodiment of the hinge assembly 200. Together, the hinge members 202 on the assembly 200 may combine to form a closed configuration. The closed configuration may comprise a continuous connection of hinge members 202. At least two of the hinge members 202 may be made up of a first interface plate 300 and a second interface plate 302. The interface plates 300, 302 are configured to connect to a first object that may be a door 107 and a second object that may be a door frame 301. The interface plates 300, 302 and the first and second objects that are shown in FIG. 3 as the door 107 and the door frame 301 may be configured to move with respect to each other. The hinge assembly 200 may provide entrance into the vehicle 100 through a process that raises the door 107 in a substantially vertical direction. Unlike hinge assemblies that permit entrance into the vehicle through moving a door in a substantially horizontal direction, the vertically oriented hinge assembly 200 may allow the vehicle 100 to park closer to foreign objects without risking a possible collision between the door 107 and the foreign objects while opening the door 107. The substantially vertically oriented opening may lead to a decreased occurrence of denting or scratching the door 107.

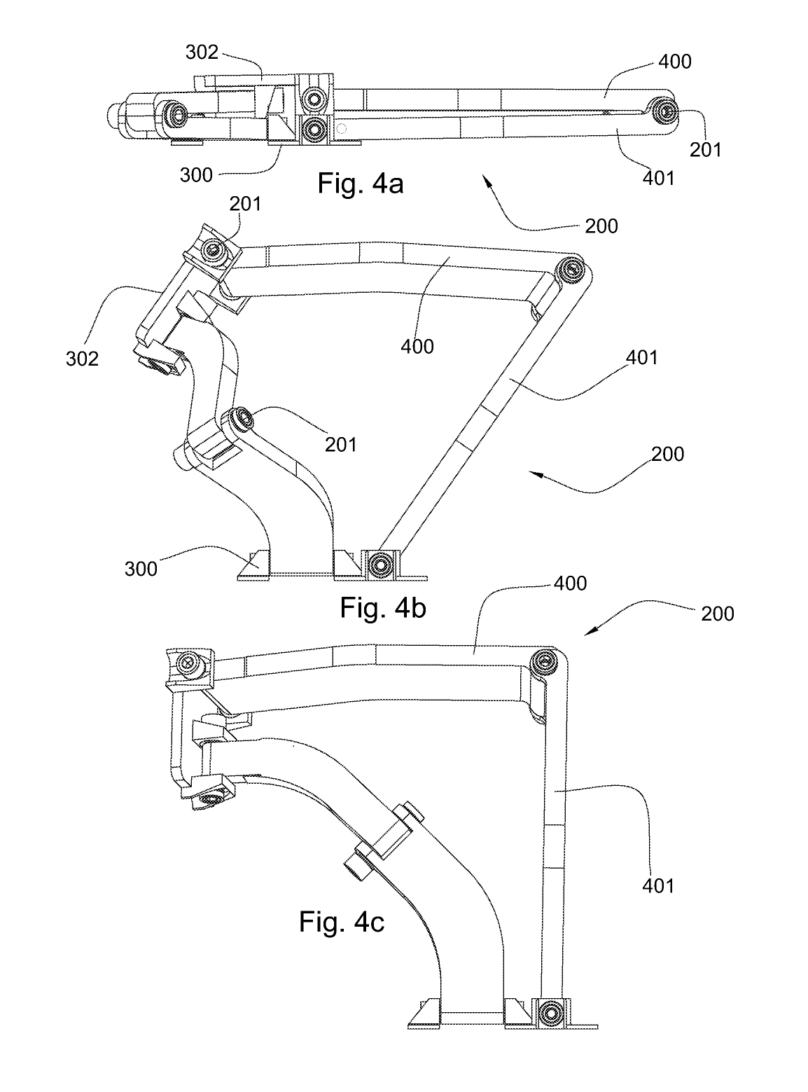

FIG. 4a discloses an embodiment of the hinge assembly 200 in a collapsed position. The hinge assembly 200 may reside in the collapsed position when entrance to the vehicle is closed and the door is shut and sealed against the vehicle. In the collapsed position, the hinge members 400, 401 may become more compact and lie in substantially parallel planes. The hinge assembly 200 may further be configured such that in the collapsed position, a first hinge member 400 is adjacent to a second hinge member 401. Close proximity of the hinge members 400, 401 may enable the door to seal against the rest of the vehicle. Each end of each hinge member 400, 401 may connect to at least one hinge joint 201. Additionally, each interface plate 300, 302 may connect to at least one hinge joint 201 enabling the hinge members 400, 401 to form an attachment to the interface plates 300, 302. The at least one hinge joint 201 may connect the interface plates 300, 302 to the hinge members 400, 401. The hinge assembly 200 may expand from the collapsed position to extend into a substantially vertical oriented position. The expansion process is exemplified in FIGS. 4b and 4c.

FIG. 4b further discloses that each interface plate 300, 302 may connect to one, but preferably at least two hinge joints 201. The two hinge joints 201 may be disposed along non-parallel planes. This may enable the hinge members 400, 401 that are attached to the hinge joints 201 to translate along different axes and enable the hinge assembly 200 to simultaneously translate vertically and horizontally, in turn simultaneously translating the door vertically and horizontally. The hinge assembly 200 may translate in one direction more substantially than in another but the assembly 200 may still translate in both directions simultaneously.

Additionally, at least one of the hinge members 400, 401 may comprise a bent geometry. The bent geometry may enable at least one interface plate 300, 302 to rotate with respect to an axis. At least one hinge member 400, 401 but preferably two hinge members 400, 401 may separate each interface plate 300, 302 from one another. The separation of the hinge members 400, 401 may provide more options for translational directions for the interface plates 300, 302 and the vehicle door that attaches to at least one of the plates 300, 302. At least two of the joints 201 may comprise non-parallel axes and may further enable the hinge assembly 200 to translate through multiple directions. The translation of joints 201 along different axes may in turn enable at least one of the hinge members 400, 401 to translate along a trajectory that comprises a continuously changing direction. This in turn may enable the vehicle door to translate both horizontally and vertically.

The interface plates 300, 302 may be configured to move relative to each other and along different axes from one another. As the first interface plate 300 translates horizontally, the second interface plate 302 may translate vertically and as the first interface plate 300 translates vertically, the second interface plate 302 may translate horizontally. Additionally, the interface plates 300, 302 may both move along the same direction. Preferably, one interface plate 300, 302 may remain stationary relative to another interface plate 300, 302 during the expanding and compacting process of the hinge assembly 200. The other interface plate 300, 302 may also remain stationary during the expanding and contracting or opening and closing processes of the hinge assembly 200. In some embodiments, the first interface plate 300 may remain stationary while the second interface plate 302 may translate. Additionally, each hinge member 400, 401 may translate independently from one other. This may enable the door on the vehicle to translate while the vehicle frame remains stationary.

FIG. 4c discloses an embodiment of the hinge assembly 200 in the expanded or opened position. The hinge assembly 200 may be configured such that a first hinge member 400 and a second hinge member 401 are not adjacent to each other while in the expanded position. The non-adjacent hinge members 400, 401 may provide support that is necessary for the door to open and remain open. Additionally, each hinge member 400, 401 may lie in a non-parallel plane when in the expanded position to further provide support to at least one of the objects. Each of the hinge members 400, 401 may be positioned substantially non-parallel with each other while in the expanded position.

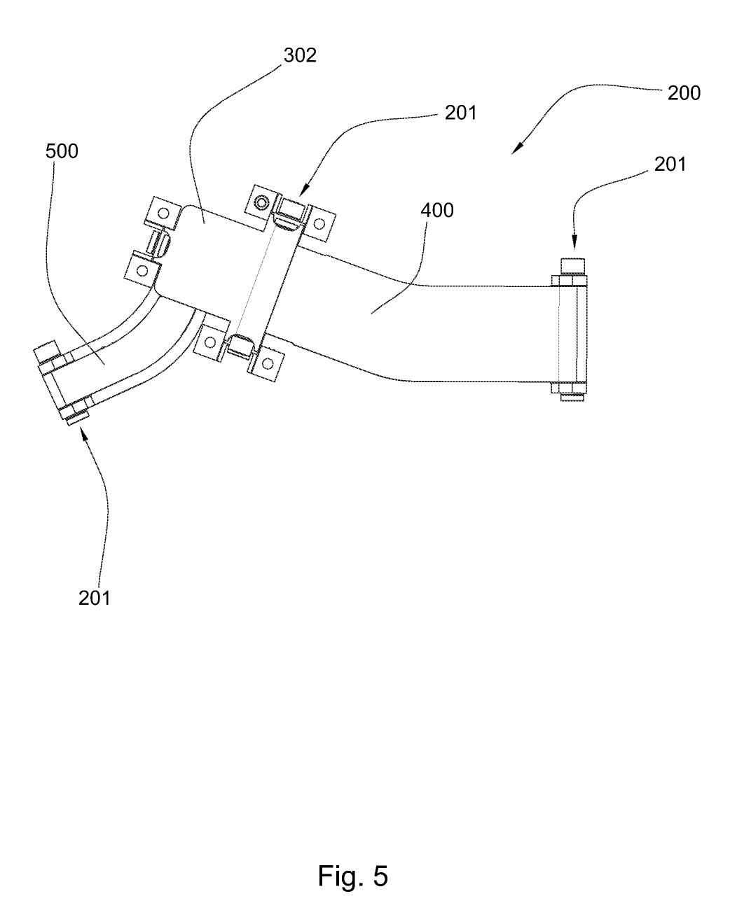

FIG. 5 discloses an embodiment of a top view of the hinge assembly 200 in the collapsed position. The second interface plate 302 is disclosed along with two hinge members 400, 500 that are attached to the plate 500. Each hinge member 400, 500 may attach to at least two hinge joints 201.

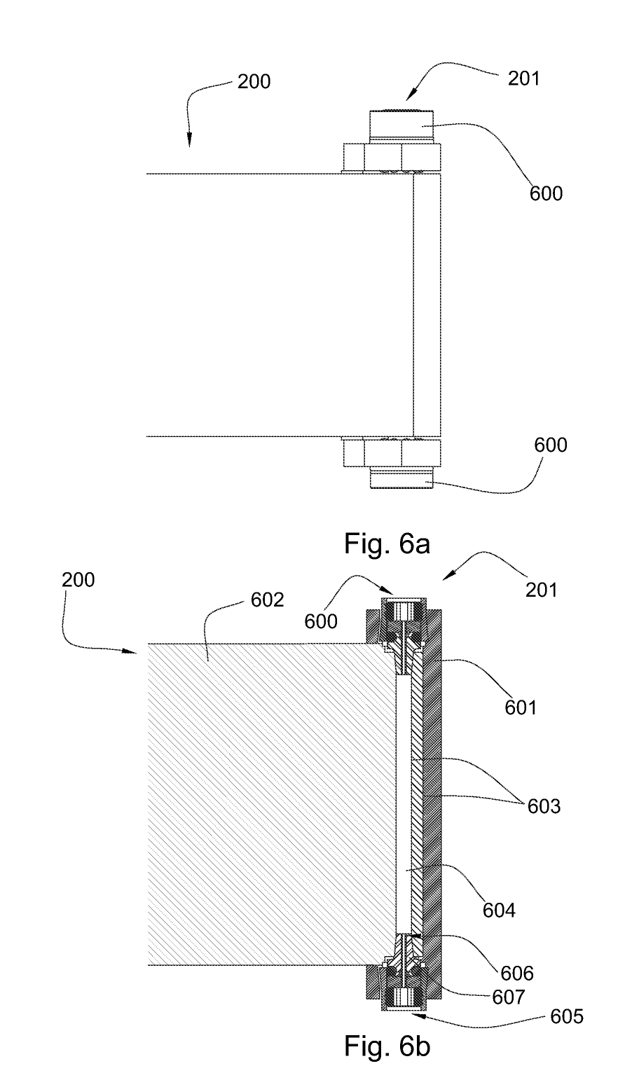

FIG. 6a discloses a detailed view of the embodiment of the hinge joint. Each hinge joint 201 may comprise at least one ball bearing insert 600, but preferably, two ball bearing inserts 600. FIG. 6b discloses a cross-sectional view of the embodiment of the hinge joint 201 with the ball bearing insert 600 received into the hinge joint 201. The hinge joint 201 may comprise first and second hinge members 601, 602 each comprising a plurality of hollow links 603. When the hollow links 603 are joined together they may form a cavity configuration 604. The cavity configuration 604 may comprise opposing openings and each opening may be configured to receive the ball bearing inserts 600. In some embodiments, the cavity configuration 604 may comprise a single cavity and in other embodiments the cavity configuration 604 may comprise multiple cavities.

The ball bearing insert 600 may comprise a distal end 605 that is connected to the first hinge member 601 and a proximal end 606 connected to the second hinge member 602. An outer surface of the proximal end 606 of the ball bearing insert 600 may comprise an outer tapered geometry and an inner surface of the cavity configuration 604 may comprise a complementary tapered geometry. The tapered geometries may aid in retaining the ball bearing insert 600 within the cavity configuration 604. A securing device that may be a peg 607 may be disposed at the proximal end 606 of the ball bearing insert 201 and the outer tapered geometry may be disposed along an outside surface of the peg 607. The outer tapered geometry of the peg 607 may begin at the proximal end 606 of the ball bearing insert 600 and increase in diameter towards the distal end 605 of the insert 600. The peg 607 may be configured to secure the ball bearing insert 600 into the cavity configuration 604 formed in the hollow links 603. The tapered geometries may create a compressive force that acts on the ball bearing insert 600. The compressive force may secure the ball bearing insert 600 into position during the translation process.

The hinge joint 201 may be assembled through a process that first, loads the distal end 605 of the ball bearing insert 600 into the first hinge member 601. The ball bearing insert 600 may comprise a casing 704 that surrounds an outside of the insert 600 intermediate the proximal and distal ends 606, 605. The casing 704 may comprise an outside tapered surface intermediate the proximal and distal ends 606, 605. Additionally, at least one of the hinge members 601, 602 may comprise an inside tapered surface. Preferably, the first hinge member 601 may comprise the inside tapered surface. The outside and inside tapered surfaces may be configured to complement each other. The outside tapered geometry may comprise a larger diameter along the proximal end 606 and decrease in magnitude towards the distal end 605 of the insert 600. The tapering may provide a force that is necessary to secure the ball bearing insert 600 into the first hinge member 601 while opening and closing the hinge assembly 200.

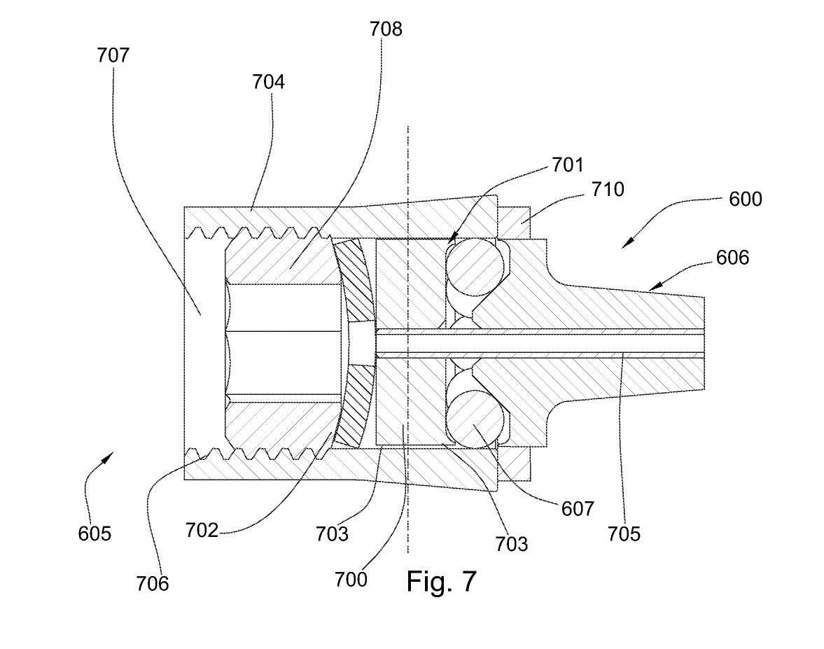

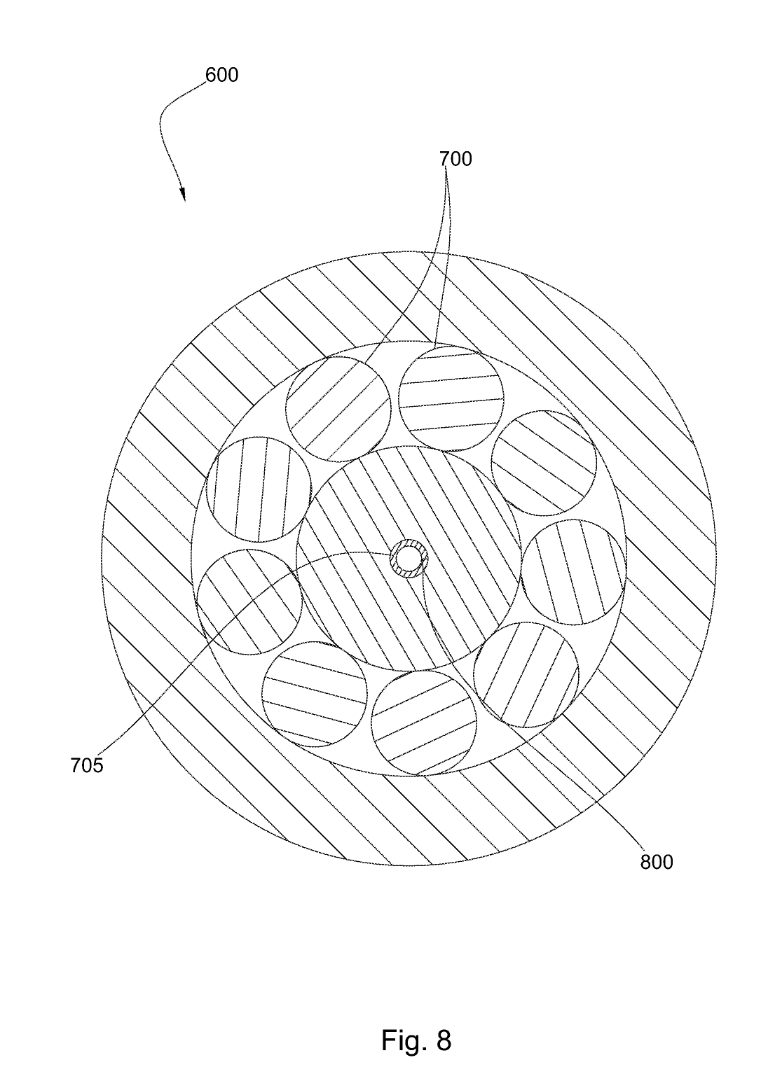

FIG. 7 discloses an embodiment of a cross-sectional view of the ball bearing insert 600. The distal and proximal ends 605, 606 of the ball bearing insert 600 may be separated by a plurality of ball bearings 700 that are disposed within a track 701 that is formed by the distal and proximal ends 605, 606 of the insert 600. A rearward end of the track may be formed within a spacer 702 that is disposed intermediate the distal end 605 of the insert 600 and the ball bearings 700. The spacer 702 may provide a flat, unyielding surface for the ball bearings 700 to be properly loaded onto. A forward end of the track 701 may be formed within the peg 607 on a ball bearing side and may be disposed at the proximal end 606 of the insert 600. The track 701 may comprise a lip 703 to further contain or secure the ball bearings 700 with the ball bearing insert 600. The lip 703 may stabilize the ball bearings 700 against the ball bearing insert 600 by providing more surface contact between the ball bearings 700 and the track 701 on the insert 600. This stabilization may increase friction that occurs between the ball bearings 700 and the ball bearing insert 600 but may also increase the lifetime of the ball bearing insert 600, in turn increasing the lifetime of the hinge joint and assembly. The increased lifetime may be more beneficial than decreasing the friction within the ball bearing insert 600. In some embodiments, the lip 703 may be formed along both the peg 607 and the spacer 702. In other embodiments, the lip 703 may only be formed along the peg 607. In yet other embodiments, the lip 703 may only be formed along the spacer 702.

The ball bearings 700 may decrease surface contact occurring between the bearings 700 and a casing 704 that surrounds an outside of the ball bearing insert 600. The track 701, casing 704, and peg 607 may be configured to contact at least one ball bearing 700 at three or more points. The ball bearings may be spherical in shape to decrease surface contact and friction that may occur. The decreased friction may increase a lifetime of the ball bearing insert 600, and may in turn increase a lifetime of both the hinge joint and the hinge assembly.

The peg 607 may secure the ball bearings 700 into place within the casing 704 of the ball bearing insert 600. A distal end of the peg 607 may comprise a surface with an angular slope. The angular surface may serve to better retain the ball bearings 700 in place while still limiting surface contact that may occur. The retained ball bearings and at least three points of surface contact may increase friction occurring between the ball bearings 700 and the peg 607, but may also increase rigidity. The benefits of increased rigidity may outweigh the negative consequences of increased friction.

Additionally, proximate the angular slope, clearance may exist between the distal end of the peg 607 and the ball bearings 700. The clearance may further decrease surface contact and result in decreasing a friction force that occurs between the ball bearings 700 and the casing 704.

A spring pin 705 may be disposed along the proximal end 606 of the ball bearing insert 600 and may extend through a center of ball bearings 700 that form a ring. The spring pin 705 may extend partially into the cavity configuration when the ball bearing insert 600 is inserted into the plurality of hollow links. The spring pin may exert a force on the ball bearings. The exerted force may retain the ball bearings 700 proximate the outside tapered surface throughout the assembling process. The exerted force may ease the assembling process by retaining the ball bearings 700. In some embodiments, the spring pin 705 may extend across the hinge joint and into another ball bearing insert 600. In some embodiments, one spring pin 705 may be provided for each ball bearing insert 600 resulting in an overall discontinuous spring pin assembly. Additionally, tolerances within the hinge joint may be less stringent because the ball bearing inserts 600 may not need to align as precisely. Preferably, after the ball bearings 700 are assembled into the ball bearing insert 600 excess length on the spring pin 705 may be removed through a trimming process. In some embodiments, the spring pin 705 may be completely removed from the ball bearing insert 600 to decrease friction that may occur.

The spring pin 705 may decrease the time required to assemble the hinge joint by simplifying and aiding in securing the ball bearings 700 into proper positioning during the assembling process. The assembly of the ball bearing insert may also be made easier through a use of grease to secure the ball bearings into place during the assembly process. The ball bearing insert 600 may require insertion into the first and second hinge members to occur along a horizontal plane. A compression may occur from the assembling of the joint insert into the hinge assembly and may secure the ball bearings 700 within the insert 600 even when the hinge assembly opens and closes along a horizontal plane.

An inside of the ball bearing insert 600 may comprise an outer surface that comprises threading 706. The threading 706 may be configured to receive a set screw 707. The set screw 707 may provide a compressive force on the ball bearing insert 600 to secure the insert 600 together. The set screw 707 may offer an adjustable mechanism to alter a magnitude of compressive forces that may occur within the ball bearing insert 600. The set screw 707 may be configured to tighten the ball bearings 700 within the insert 600 to provide constant force on the ball bearing insert 600. The constant force may ensure that the ball bearing insert 600 maintains maximum lifetime expectancy.

Additionally, a biasing mechanism 708 may be disposed within the ball bearing insert 600 intermediate the proximal and distal ends 606, 605 of the insert 600 between the set screw 707 and the spacer 702. The biasing mechanism 708 may be configured to provide a constant force to the ball bearing insert 600. During use of the hinge joint, the ball bearings 700 may wear into the casing 704, peg 607, spacer 702, or possibly another part of the ball bearing insert 600. The wear may create unwanted vacancies around the ball bearings 700 that may decrease the lifetime of the ball bearing insert 600. The biasing mechanism 708 may ensure that forces acting on the ball bearing insert 600 are kept constant, which in turn may maintain constant rigidity in the joint.

The ball bearing insert 600 may further comprise an o-ring 710 proximate the proximal end 606. The o-ring 710 may form a seal along the proximal end 606 of the insert 600. The seal may prevent debris from entering into the ball bearing insert 600 and jeopardizing a lifetime of the insert 600. The o-ring may also prevent lubrication within the ball bearing insert 600 from escaping. This may allow the lubrication to last longer within the ball bearing insert 600 and increase the lifetime of the insert as a result.

FIG. 8 discloses a cross-sectional view of an embodiment of the ball bearing insert 600 where the view is taken from a cut through the middle of the ball bearings 700. The spring pin 705 may be disposed substantially through a center of the ball bearing insert 600. The spring pin 705 may increase compression within the ball bearing insert 600 by decreasing vacancies that may occur within the ball bearing insert 600. Additionally, the spring pin 705 may comprise a slot 800 that is formed through at least a portion of a length of the spring pin 705. The slot 800 may be configured to resiliently collapse the spring pin 705 upon insertion into the ball bearing insert 600. The compression of the spring pin 705 may ensure that the pin 705 stays firmly within the ball bearing insert 600 during use of the hinge assembly. The spring pin 705 may further be configured to increase rigidity between the proximal and distal ends of the ball bearing insert 600. The increased rigidity may maintain the integrity of the ball bearing insert 600 for a greater period of time.

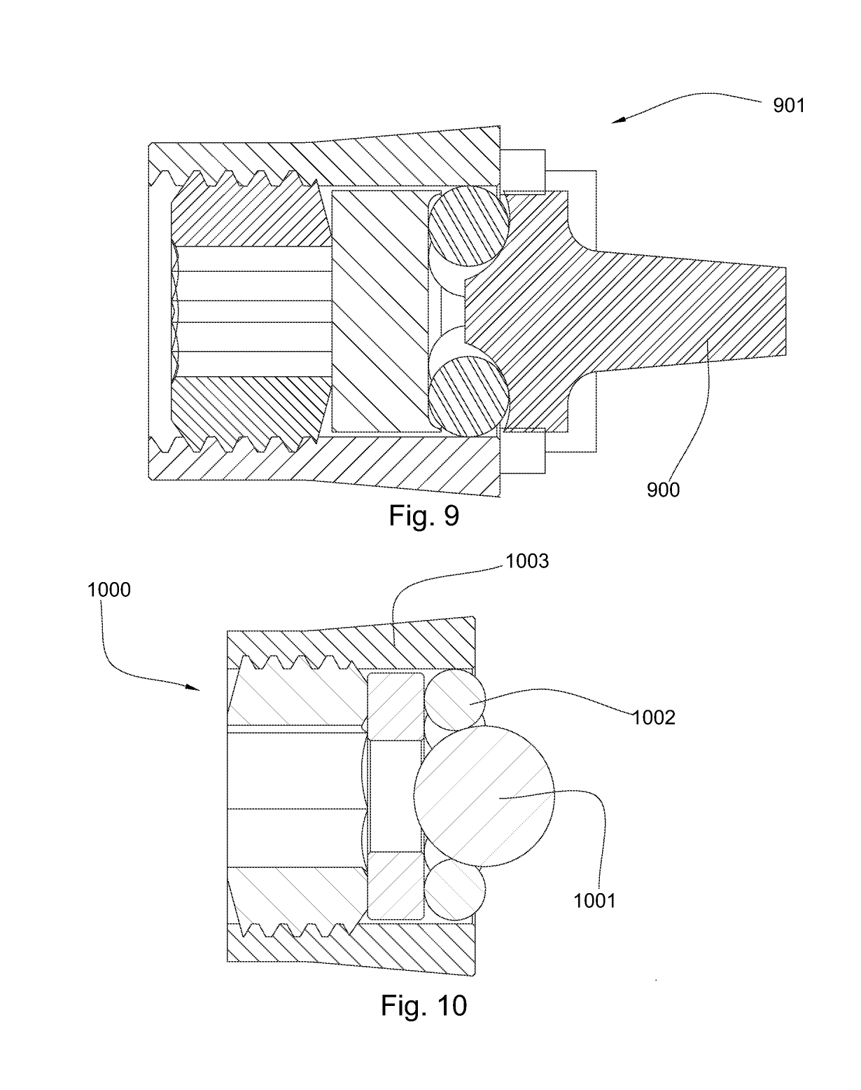

FIG. 9 discloses a cross-sectional view of an embodiment of a ball bearing insert 901. The ball bearing insert 901 may comprise a securing device that may be a peg 900. The peg 900 may comprise a continuous outside surface. The peg 900 may further comprise a solid structure.

FIG. 10 discloses a cross-sectional view of an embodiment of a ball bearing insert 1000. The ball bearing insert 1000 may comprise a securing device that may be a large ball bearing 1001. The large ball bearing 1001 may be larger in size than a plurality of ball bearings 1002 that may be positioned around the large ball bearing 1001. The large ball bearing 1001 may reduce surface contact that may occur between the ball bearings 1001, 1002 and a casing 1003 of the ball bearing insert 1000. A front end of the large ball bearing 1001 may enter into a hollow link formed by a first and second hinge member.

Whereas the present invention has been described in particular relation to the drawings attached hereto, it should be understood that other and further modifications apart from those shown or suggested herein, may be made within the scope and spirit of the present invention.

What is claimed is:

1. A hinge assembly, comprising:
a plurality of hinge members moveably coupled by a plurality of hinge joints;
at least two of the hinge members are object interface plates configured to connect to first and second objects that are configured to move with respect to each other;
the plurality of hinge members forms a closed configuration;
each interface plate is connected to at least two hinge joints;
at least two of the hinge joints comprise non-parallel axes; and
each hinge joint is configured to move simultaneously.

2. The assembly of claim 1, wherein at least one of the hinge members comprises a bent geometry.

3. The assembly of claim 2, wherein the bent geometry enables at least one interface plate to rotate with respect to an axis.

4. The assembly of claim 1, wherein at least one of the hinge members is configured to translate along a trajectory that comprises a continuously changing direction.

5. The assembly of claim 1, wherein the hinge assembly is configured to collapse into a compact position where all of the hinge members lie in substantially parallel planes.

6. The assembly of claim 1, wherein the assembly is configured such that a first hinge member is adjacent to a second hinge member when in a collapsed position.

7. The assembly of claim 1, wherein the assembly is configured such that first and second hinge members are not adjacent to each other when in an expanded position.

8. The assembly of claim 1, wherein each of the hinge members are positioned to be substantially non-parallel with one another in an expanded position.

9. The assembly of claim 8, wherein the substantially non-parallel hinge members are configured to support at least one of the objects when in the expanded position.

10. The assembly of claim 1, wherein at least one interface plate remains stationary during an expansion and compression process of the hinge assembly.

11. The assembly of claim 1, wherein each end of the hinge member is connected to at least one hinge joint.

12. The assembly of claim 1, wherein the interface plates are configured to move relative to each other.

13. The assembly of claim 1, wherein a first interface plate is connected to a door and a second interface plate is connected to a door frame.

14. The hinge assembly of claim 1, wherein each of the hinge members translate independently from each other.

15. The assembly of claim 1, wherein each hinge joint comprises at least one ball bearing insert.

16. The assembly of claim 1, wherein the closed configuration comprises a continuous connection of hinge members.

17. The assembly of claim 1, wherein the at least two hinge joints that comprise non-parallel axes enable the hinge assembly to translate in multiple directions.

18. The assembly of claim 1, wherein the hinge assembly is configured to collapse into a compact position enabling the hinge assembly to form a seal with the first and second objects.

19. The assembly of claim 1, wherein the hinge members may comprise different widths.

20. The assembly of claim 1, wherein the hinge joint comprises a seal along an outer surface to prevent debris from entering into the hinge joint.
